(19) United States
(12) Patent Application Publication
(10) Pub. No.: US 2007/0203891 A1
(43) Pub. Date: Aug. 30, 2007

(54) Providing and using search index enabling searching based on a targeted content of documents

(75) Inventors: John A. Solaro, Bellevue, WA (US); Keith D. Senzel, Seattle, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 11/364,040

(22) Filed: Feb. 28, 2006

(51) Int. Cl. G06F 17/30

(52) U.S. Cl. 707/3

(57) ABSTRACT

A search index referencing document includes targeted content indicators. A process first identifies documents in the search index for targeted content analysis. Each document identified is then analyzed with a targeted content metric to produce a targeted content indication that is associated with the document in the search index. For example, a metadata score can be appended to the reference to the document in the search index. When a search query that includes a targeted content request is subsequently received from a user device, search results are produced by limiting the results displayed to those related to the targeted content requested. For example, the request may be for documents that are educationally relevant. The results displayed to the user can be ordered based on the targeted content indicated associated with each document listed.

### BACKGROUND

Most modern Internet search engines utilize some combination of two distinct calculations to determine which documents to return and in what order in response to a search query: relevancy score and static rank. The relevancy score is a measure of how “relevant” a particular document is to the word or words that are entered in a search. The static rank, sometimes referred to as “PageRank” or link popularity, is a measure of how “important” a particular document is in comparison to all other documents in the index, and is unrelated to the specific search term included in the search query. In general, these two scores are combined in varying degrees to determine which documents rank higher on a search results page for a given search term, and which documents rank lower.

Static rank can be an effective solution in determining the importance of a particular page in comparison to documents on the Internet. However, static rank calculations usually take only one dimension of “importance” into account. As such, these calculations only reflect how many links from other documents are pointing to a specific document and the respective static ranks of the referring documents. This method is effective for the purposes of a general web search, but does not account for all of the other possible dimensions of a document that are necessary to determine how important it is for the purposes of a domain specific, subject matter search.

Many new search engines, and new features for existing search engines, are being developed that focus on one specific “vertical” subject matter domain to provide shopping searches, blog searches, research searches, and the like. However, the static rank of the documents in the index only takes into account generic pagerank attributes, not attributes related to a specific vertical that targets specific subject matter. Therefore, the static rank is not useful for filtering the index for particular attributes of the vertical in question, which critically limits the effectiveness and utility of these vertical search engines for users. For example, present vertical engine implementations cannot additionally provide document ranking of search results that is tailored to the specific environment of a school, where some results are inappropriate, and other results more favored. Accordingly for such searches, a “Learning Rank” would be very useful to help determine the order of search results for students searching for educationally-related documents for various school projects. Thus, advances in search technology that offer efficient search capabilities, yet can return results based upon a specific area of interest to the searcher, will be of interest for educational, as well as for commercial, and home use.

### SUMMARY

As explained in greater detail below, various computer implemented techniques are described for providing and searching a search index that enables searching based upon a targeted content indicator. In particular, the targeted content indicator is used for identifying a specific targeted content, for example, documents referenced in the search index in regard to their relevance to a specific targeted content associated with the documents. In one example discussed in detail below, the targeted content indicator is associated with documents in the search index to provide a basis for determining the relevance of the documents to education.

In one exemplary embodiment, the technique includes the step of receiving a search request for a document search from a user device. If the received search request includes a targeted content request for restricting search results to a specific targeted content, for example, to educational related documents, the search request is then submitted to a search index having entries that include targeted content indicators for each document referenced in the search index. The targeted content indicators can be based on a pre-evaluated targeted content analysis of the documents, for example to identify relevant factors pertaining to education. Documents in the search index having targeted content indicators related to the specific targeted content will then be returned in response to the search request. Search results returned by the search can be ordered in a targeted static rank based on the relative values of targeted content indicators for the documents associated with each search index document listed in the results of the search.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is a functional block diagram of a generally conventional computing device that is suitable for implementing the present novel approach;

FIG. 2 is a functional block diagram of a server farm for implementing web crawling used to produce a search index of entries associated with targeted content indications, and for implementing other functions related to the search index, such as providing a targeted content indicator for documents referenced by the search index, and searching the search index for documents associated with a specific targeted content;

FIG. 3 is a flow diagram illustrating an exemplary method for providing a search index that is searchable by a targeted content indication of the documents referenced in the data included in the search index; and

FIG. 4 is a flow diagram illustrating the steps of an exemplary method for searching a search index that is searchable using the targeted content indication.

### DESCRIPTION

### Figures and Disclosed Embodiments are Not Limiting

Exemplary embodiments are illustrated in referenced Figures of the drawings. It is intended that the embodiments and Figures disclosed herein are to be considered illustrative rather than restrictive. Furthermore, in the claims that follow, it will be understood that when a list of alternatives uses the conjunctive “and” following the phrase “at least one of,” or following the phrase “one of,” the intended meaning of “and” corresponds to the conjunctive “or.”

### Exemplary Computing System

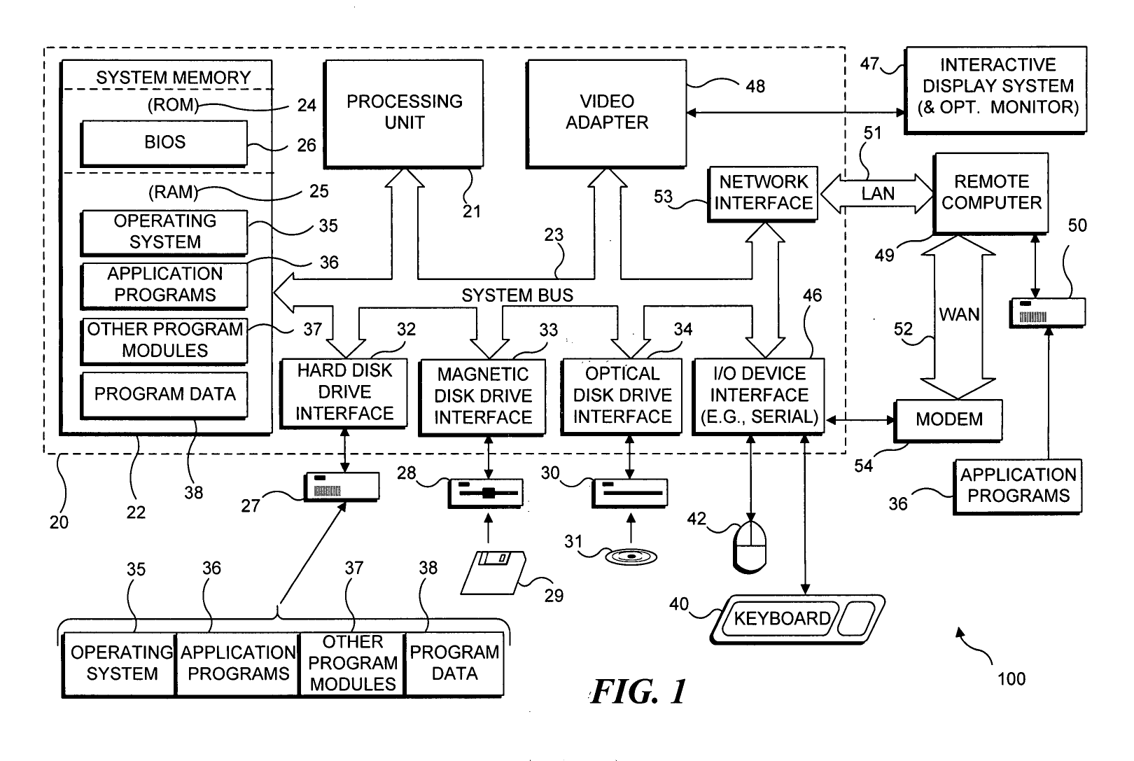

FIG. 1 is a functional block diagram of an exemplary computing device 100 that can be used for requesting a search as described below or can be used to respond to the request for a search, or to provide a search index that can be searched using targeted content indicators associated with documents referenced in the search index. It will be understood that searches of this type can be conducted locally on a single computing device, or by transmitting a search request from one computing device to a server or other remote computing device, such as over a network, or the Internet.

The following discussion is intended to provide a brief, general description of a suitable computing environment in which the techniques or approaches discussed below may be implemented. Further, the following discussion illustrates a context for implementing computer-executable instructions, such as program modules, with a computing system. Generally, program modules include routines, programs, objects, components, data structures, etc., that perform particular tasks or implement particular abstract data types. The skilled practitioner will recognize that other computing system configurations may be applied, including multiprocessor systems, mainframe computers, personal computers, processor-controlled consumer electronics, personal digital assistants (PDAs), and the like. One implementation includes distributed computing environments where tasks are performed by remote processing devices that are linked through a communications network. In a distributed computing environment, program modules may be located in both local and remote memory storage devices.

With reference to FIG. 1, an exemplary system suitable for implementing various functions described below is depicted in a functional block diagram. The system includes a general purpose computing device in the form of a conventional PC 20, provided with a processing unit 21, a system memory 22, and a system bus 23. The system bus couples various system components including the system memory to processing unit 21 and may be any of several types of bus structures, including a memory bus or memory controller, a peripheral bus, and a local bus using any of a variety of bus architectures. The system memory includes read only memory (ROM) 24 and random access memory (RAM) 25.

A basic input/output system 26 (BIOS), which contains the fundamental routines that enable transfer of information between elements within the PC 20, such as during system start up, is stored in ROM 24. PC 20 further includes a hard disk drive 27 for reading from and writing to a hard disk (not shown), a magnetic disk drive 28 for reading from or writing to a removable magnetic disk 29, and an optical disk drive 30 for reading from or writing to a removable optical disk 31, such as a compact disk-read only memory (CD-ROM) or other optical media. Hard disk drive 27, magnetic disk drive 28, and optical disk drive 30 are connected to system bus 23 by a hard disk drive interface 32, a magnetic disk drive interface 33, and an optical disk drive interface 34, respectively. The drives and their associated computer readable media provide nonvolatile storage of computer readable machine instructions, data structures, program modules, and other data for PC 20. Although the described exemplary environment employs a hard disk 27, removable magnetic disk 29, and removable optical disk 31, those skilled in the art will recognize that other types of computer readable media, which can store data and machine instructions that are accessible by a computer, such as magnetic cassettes, flash memory cards, digital video disks (DVDs), Bernoulli cartridges, RAMs, ROMs, and the like, may also be used.

A number of program modules and/or data may be stored on hard disk 27, magnetic disk 29, optical disk 31, ROM 24, or RAM 25, including an operating system 35, one or more application programs 36, other program modules 37, and program or other data 38. A user may enter commands and information in PC 20 and provide control input through input devices, such as a keyboard 40 and a pointing device 42. Pointing device 42 may include a mouse, stylus, wireless remote control, or other user interactive pointer. As used in the following description, the term “mouse” is intended to encompass any pointing device that is useful for controlling the position of a cursor on the screen. Other input devices (not shown) may include a microphone, joystick, haptic joystick, yoke, foot pedals, game pad, satellite dish, scanner, or the like. Also, PC 20 may include a Bluetooth radio or other wireless interface for communication with other interface devices, such as printers, or a network. These and other input/output (I/O) devices can be connected to processing unit 21 through an I/O interface 46 that is coupled to system bus 23. The phrase “I/O interface” is intended to encompass each interface specifically used for a serial port, a parallel port, a game port, a keyboard port, and/or a universal serial bus (USB). Optionally, a monitor 47 can be connected to system bus 23 via an appropriate interface, such as a video adapter 48. In general, PCs can also be coupled to other peripheral output devices (not shown), such as speakers (through a sound card or other audio interface—not shown) and printers.

In general, the approach described in detail below can be practiced on a single machine, although PC 20 can also operate in a networked environment using logical connections to one or more remote computers, such as a remote computer 49. Remote computer 49 can be another PC, a server (which can be configured much like PC 20), a router, a network PC, a peer device, or a satellite or other common network node, (none of which are shown), and a remote computer will typically include many or all of the elements described above in connection with PC 20, although only an external memory storage device 50 for the remote computing device has been illustrated in FIG. 1. In many cases, PC 20 will be used to transmit a search request or query over a network to a server (which is generally similar to PC 20) to identify documents with a specific targeted content. The logical connections depicted in FIG. 1 include a local area network (LAN) 51 and a wide area network (WAN) 52. Such networking environments are common in offices, enterprise-wide computer networks, intranets, and the Internet.

When used in a LAN networking environment, PC 20 is connected to LAN 51 through a network interface or adapter 53. When used in a WAN networking environment, PC 20 typically includes a modem 54, or other means such as a cable modem, Digital Subscriber Line (DSL) interface, or an Integrated Service Digital Network (ISDN) interface for establishing communications over WAN 52, such as the Internet. Modem 54, which may be internal or external, is connected to the system bus 23 or coupled to the bus via I/O device interface 46, i.e., through a serial port. In a networked environment, program modules, or portions thereof, used by PC 20 may be stored in the remote memory storage device. It will be appreciated that the network connections shown are exemplary and other means of establishing a communications link between the computers may be used, such as wireless communication and wide band network links.

### Exemplary Operating Environment

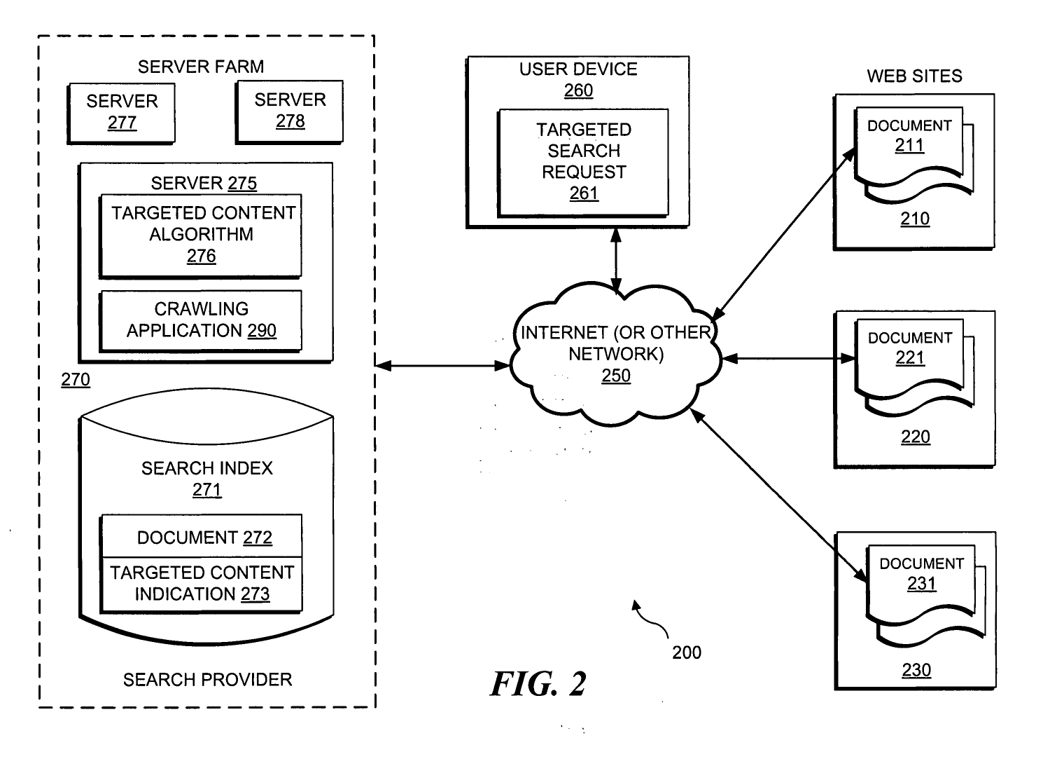

FIG. 2 is a block diagram of an exemplary operating environment 200 for implementing various methods of generating a search index of documents having associated targeted content and processing search requests to search a search index that includes a targeted content indication for documents referenced by the search index. As used herein and in the claims that follow, the term “documents” is intended to broadly apply to any entity that might be referenced and returned in a search result, and can include without limitation, text, graphics, images, sound files, video files, and almost any other form of file that can be identified as relating to or being associated with a specific targeted content. FIG. 2 shows a search provider 270, and such a search provider is likely to be implemented using a “server farm” that includes exemplary servers 275, 277 and 278 that are used to provide an indexing (i.e., to provide a search index for documents that are associated with a targeted content indication included in the search index, to facilitate a search with documents associated or relating to a specific targeted content. It will be understood that many more or fewer servers may be included at the search provider facilities, and that the servers may be disposed at physically different sites. Further, it will be understood that in another exemplary embodiment, the search index can be provided on the same computing device that is operated by a user requesting the search for documents associated with a specific targeted content.

Server 275 is illustrated as being capable of executing a targeted content algorithm 276 used to determine targeted content indications for documents referenced by search index 271. Search provider 270 stores search index 271 (e.g., on one or more hard drives). The search index is shown as including a document 272 that is associated with a targeted content indication 273, which may be typical of a plurality of such documents, perhaps many thousands, or perhaps only a very few. Server farm 270 is shown as communicating over the Internet (or other network) 250, with a user device 260 and with three web sites 210, 220, and 230. What is meant by the phrase “targeted content” is any content that is related to or associated with a specific subject matter. For instance, without intending to be limiting in any way, several exemplary “targeted content” topics include: education and learning, news, sports, politics, and shopping. It will be apparent that each of these exemplary topics are each representative of targeted content for which a user may desire to search. Many other topics can be selected for use in providing a search index that can facilitate searching for such topics. It should also be emphasized that a search index can include targeted content indications for a plurality of different topics and need not be limited to only one or a few topics. As a further example, some of the documents referenced in a search index may be associated with a targeted content indication for a broad topic such as sports, while certain of those documents are associated with a targeted content indication for a more specific sports topic, such as swimming. Accordingly, it should be apparent that a document referenced in the search index can be associated with a targeted content indication related to more than one topic or type of targeted content.

As shown in FIG. 2, user device 260 has initiated a targeted search request or query 261, which is communicated to search provider 270, to request a result derived from searching search index 271, but limited to document(s) having a targeted content indication corresponding to a specific subject matter (targeted content) identified by the search request. Web site 210 is shown including an exemplary Web document 211. Likewise, web sites 220 and 230 each include exemplary Web documents 221 and 231, respectively, and may be part of a single shared domain, or in separate sub domains, or in a combination of linked domains on one or more servers and may be in one or more physical locations. In one implementation (not shown), a plurality of documents analogous to documents 211, 221, and 231 can be documents stored on a single PC and referenced in a search index on the single PC, which can be searched by a desktop search utility running on the PC. The PC may be user device 260, so that a search request concerning a targeted content subject area will be searching for one or more documents referenced in the search index of user device 260.

In the example illustrated in FIG. 2, search provider 270 can be any combination of computing devices, databases, and communication infrastructure suitable for operating a backend operation to provide search engine functionality that is able to implement a targeted search of an appropriate search index. Search providers and their attendant structures are well known in the art and as such, the following discussion will be limited to only those conceptual elements that are actually necessary for conveying an enabling disclosure of an exemplary system and method for carrying out the novel approach disclosed herein. It will be understood, then that a search provider can include additional components that are not illustrated in the instant example.

Servers 275, 277, and 278 of search provider 270 can be any computing devices designed for operation in a highly networked parallel computing environment, as is known in the art. In one example, each of servers 275, 277, and 278 is a computer device like PC 20 of FIG. 1. Similarly, user device 260 can be any computing device suitable for creating and communicating a targeted search request and receiving and displaying the search result, and may be, for example, a personal data assistant, a laptop computer, or other type of computing device that can access the search index.

Targeted content algorithm 276 can be any algorithm suitable for evaluating a document based on certain predetermined criteria. These predetermined criteria can take many forms, including lists of approved universal resource locators (URL) for documents likely to be associated with a targeted content, Internet domain extensions (e.g., “.edu” and “.gov”) that are likely to have some relevance to a specific targeted content (e.g., education), and words and/or phrases that have particular relevance to specific areas of interest corresponding to the targeted content. In another example related to education targeted content, the predetermined criteria can include a range of readability scores based on evaluation by readability algorithms, such as those based on the Flesch-Kincaid formula for readability. Other examples of predetermined criteria include lists of specific documents, and content that has been pre-approved or disapproved by a specific agency, such as an editorial board tasked with evaluating document content for inclusion in a resource (e.g., in an online encyclopedia).

In some implementations, the targeted content algorithm can be employed to generate targeted content indication 273, which can then be associated with document 272 in the search index, after analysis with algorithm 276. In other implementations, the targeted content indication can be metadata that is appended to the reference to the document in the search index. In one example, the targeted content indication for a document can be a numerical score that rates a relevance of the document to a specific subject matter (i.e., the targeted content), where the numerical score is determined based on the predetermined criteria that are applied when analyzing the document with the targeted content algorithm. In another implementation, the targeted content indication can be dynamically determined by the targeted content algorithm by accessing a database (not shown) of various predetermined criteria that apply to specific targeted content or subject matter topics.

Internet (or other network) 250 communicates signals between user device 260 and web sites, 210, 220, and 230. In one implementation, Internet (or other network) 250 can be configured to enable an agent application 290 (e.g., a Web crawling program) running on any of servers 277, 278, and 275 to identify documents, such as hypertext markup language (HTML), extensible markup language (XML), and other types of Web documents that are accessible over the Internet (or other network), so that the analysis can be applied to the document to determine a targeted content indication for the document. In another application, Internet (or other network) 250 can convey calls to dedicated application program interfaces (APIs) for analysis of selected documents for relevance to predetermined targeted search subjects and interest areas, when the references to the documents are added to search index 271. The references for each document added will then include an associated targeted content indication for the document, which can be a positive value, zero, or even a negative value in some implementations. It could also be null if, for example, the document has not yet been fully analyzed.

### Exemplary Method for Generating a Search Index Having Documents Associated with Targeted Content Indications

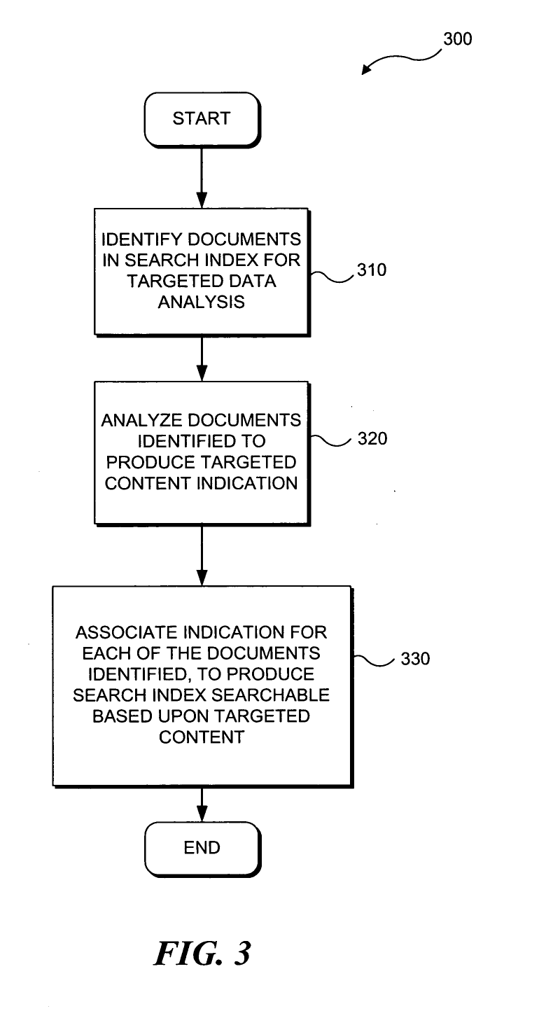

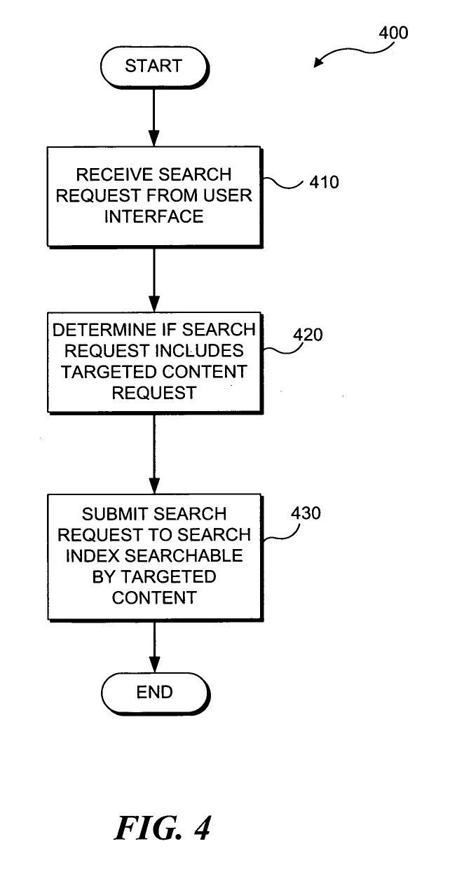

In the following discussion, FIGS. 3 and 4 refer to computer implemented methods that can be implemented in some embodiments with components, devices, and techniques as discussed with reference to FIGS. 1-2. In some implementations, one or more steps of the method embodied in exemplary flowcharts 300 and 400 are carried out when machine executable instructions stored on a computer readable medium are executed on a computing device, such as by a processing unit 21 in PC 20 (FIG. 1). In the following description, various steps of the exemplary methods shown in flowcharts 300 and 400 are described with respect to one or more processors performing the steps. In some implementations, certain steps of flowcharts 300 and 400 can be combined, and performed simultaneously or in a different order, without deviating from the objective of the method or without producing different results.

FIG. 3 is an exemplary flowchart 300 illustrating an exemplary method for providing a search index that is searchable by targeted content indications associated with each document (or similar entity) referenced in a search index. The exemplary method of flowchart 300 begins at a step 310. It should be noted that the method illustrated in flowchart 300 can generally be carried out as a back-office function, i.e., the method is not invoked as a run-time operation in conjunction with a search inquiry, but rather operates as a background operation independent of any user initiated search activity and is preferably done before targeted content searching of the search index is carried out.

In step 310, documents in the search index are identified for targeted content analysis. A document can be identified at any time that a computing system executes appropriate machine instructions. In some implementations, the machine instructions comprise an agent algorithm that is employed to identify documents for addition to the search index, at which point the document can also be identified for targeted content analysis. Agent algorithms, spiders and Web crawlers capable of identifying documents for inclusion in a search index are well known to those skilled in the art, and therefore will not be discussed in detail.

In a step 320, a document referenced in the search index is analyzed with a targeted content metric to produce the targeted content indication. In some implementations, the targeted content indication comprises a document quality score that is determined based on the targeted content metric.

One implementation includes further steps, such as applying the targeted content metric to identify any predetermined criteria associated with the document that are indicative of the relevance of the document to a specific targeted content or subject matter. In some embodiments, these predetermined criteria can include, without limitation, a universal resource locator indicating a storage location for documents likely to be relevant to the targeted content, an Internet domain where such documents are likely to be found, a list of content selected by an editorial board, where the content relates to the specific targeted content, a readability score (e.g., for educational targeted content), a document flag indicating a parameter of the documents likely to be relevant to a specific targeted content, and a disapproved content list.

An individual quality score can then be assigned for each of the predetermined criterion identified for a document. Finally, a document score can be generated based on an aggregation of each individual quality score. In one implementation, the method can further include the steps of determining a conventional static rank calculation for the identified document, and then applying the static rank calculation that was determined as a seed value for the document score, prior to aggregating the quality scores. Another implementation includes the step of generating a positive score for an approved criterion, and generating a negative score for a disapproved criterion. For example, a preapproved root URL, a specified domain, or a document having a research or learning flag added using automated tagging can be given a positive or “bonus” document score, while a document flagged as being for a shopping or commercial Web page or having a blocked root URL for a Web site that includes advertising material might be given a negative or “penalty” document score. Thus, by aggregating all positive and negative document scores generated during the analysis of the document, the targeted content indication is determined for the document. The foregoing process can be iterative.

In a step 330, the targeted content indication is associated with the document in the search index. In one implementation, associating the targeted content indication with the document includes appending a metadata targeted content indication to the document.

In this implementation, the targeted content indication can describe a relevance to a specific targeted content topic. For example, the targeted content indication can indicate that the document includes text or graphics related to interest areas such as education, sports, business, vehicles, politics, news, shopping, health, and travel. The foregoing list is not meant to be exhaustive or in any way limiting, but is merely exemplary of the types of targeted content subject matter that might be of interest to users. The flexibility of the targeted content indication enables an enormous variety of different interest areas to be searched within a search index that includes pre-analyzed documents having targeted content indications for each of those interest areas.

Another implementation employs an agent algorithm to first identify documents for addition to the search index and then for each document that is identified, generates a new record for the document within the search index that includes a targeted content indication for each area of interest that will be searchable by targeted content in the search index. In this manner, the search index can be updated periodically with new documents and still be searchable by targeted content indicators. Similarly, the types of targeted content can be updated or changed as desired, by analyzing each document referenced by the search index for any new or different targeted content that is currently important.

In some implementations, in response to a search inquiry, an ordered set of a plurality of documents referenced in the search index is produced based on the targeted content indication associated with each of the plurality of documents. Stated differently, the rank of each document within the ordered set can be based on the relative values of the targeted content indication for each document, thereby allowing an objective ordering of the plurality of document based on their relevance in a targeted static ranking.

FIG. 4 is an exemplary flowchart 400 illustrating an exemplary method for enabling an educationally targeted search query of a search index having a plurality of document entries. The exemplary method of flowchart 400 begins at a step 410.

In step 410, a search query or request for a document search is received from a user device. The search request can be received at any time that a user device and a computing system hosting a search index are in communication. As noted above, the user device can be any device such as PC 20 (FIG. 1) that is suitable for submitting a search request and receiving search results.

A step 420 determines if the search request includes a targeted content request for restricting search results to educationally targeted documents (i.e., in this example—it will be understood that the search request could instead be limited to a different targeted content). In some implementations, the targeted content search request can be in the form of a unique application programming interface (API) specific to a targeted content subject matter, such as those described above with reference to flowchart 300. In other implementations, the targeted content request can be an indicator provided in a search request header, or can be an automatically appended indication based upon the user accessing a search request tool through a specific user interface. In one example, a specific user interface related to the targeted content topic can be implemented to provide user access to targeted content for that topic, e.g., a search interface specifically directed to news, or sports, or education/learning searches. It should be noted that in the foregoing example, each specific user interface accesses the same search index rather than one of a plurality of different search indexes that are each directed to a different topic. Conversely, a specific different search index could be accessed for each search request that is directed to a different targeted content.

In a step 430, the search request is submitted to the search index. In this implementation, each document entry of the search index includes a targeted content indicator that is based on a pre-evaluated targeted content analysis of the document that is thus referenced in the search index. Generally, the search request can be submitted to the search index at any time that the search index is available for searching. One implementation includes a further step of generating a search result list from the submitted search request. In this implementation, the search result list is based on a search for document entries referenced in the search index with targeted content indications that match the targeted content request.

In another implementation, the targeted content indicator comprises a targeted content score that is based on predetermined criteria. In this implementation, the targeted content score can be a positive value, zero, or a negative value, thereby allowing positive or “bonus,” and negative or “penalty” scores for approved and disapproved document content, respectively. Another implementation includes searching the search index for documents having only a positive targeted content score, to be returned in a final listing of documents provided as the search results. In certain implementations, a “zero” score can be treated as either a positive or a negative score, depending upon the configuration or choice of the search program designer. For example, if the search index returns very few documents based upon a search for positive targeted content score, a “zero” score can be included as a positive targeted content score. However, if a large number of documents are returned based upon the search for positive targeted content scores, “zero” scores can be eliminated by treating them the same as negative scores. Therefore, a zero score may indicate that a document is neither pre-approved or disapproved, and may or may not have relevance to the targeted content topic. In other implementations, however, a “zero” score can indicate no relevance to the targeted search topic whatsoever, or that the document is disapproved based on predetermined criteria such as being associated with a blocked URL list, or as pertaining to unsuitable subjects, such as pornography.

Yet another implementation includes a step of ordering the search result list based on the relative values of the targeted content score for each document included in the final list that is returned. In this implementation, the ordering of the search result list can additionally be based upon conventional static and dynamic ranks. In this manner, a search result list can be provided that includes a ranking of page importance, relevancy to a specific search term, and relevance to a specific targeted content topic.

Another implementation includes the steps of initially including each document having a negative targeted content score in the search result list, and then eliminating all such document from a modified search result list. The modified search result list can then be sorted in order to produce a final search result list of documents having only positive targeted content scores that are sorted by the relative values of the targeted content scores. Still another implementation includes a step of providing the search result list to a user device for display on a user display device. In this implementation, the search result list can be provided to the user device at any time after the search result list is generated, and may comprise the final search result list discussed above. In some implementations, the provided search result list can be based upon static and dynamic ranks, as well as targeted content indication scores.

Although the present invention has been described in connection with the preferred form of practicing it and modifications thereto, those of ordinary skill in the art will understand that many other modifications can be made to the present invention within the scope of the claims that follow. Accordingly, it is not intended that the scope of the invention in any way be limited by the above description, but instead be determined entirely by reference to the claims that follow.

The invention in which an exclusive right is claimed is defined by the following:

1. A computer implemented method for providing a search index that is searchable by a targeted content indication associated with each of a plurality of entries in the search index, comprising the steps of:
(a) identifying documents in the search index for targeted content analysis;
(b) analyzing each document identified with a targeted content metric to produce the targeted content indication for the document, wherein the targeted content indication comprises a document quality score for each such document that is determined based on the targeted content metric of the document; and
(c) associating the targeted content indication for each document identified, to enable the search index to be searched for the targeted content.

2. The method of claim 1, wherein the step of analyzing the document comprises the steps of:
(a) applying the targeted content metric to identify at least one predetermined criterion associated with the document;
(b) assigning an individual quality score for each of the predetermined criterion identified in each document being analyzed; and
(c) generating the document quality score for each document being analyzed, based on an aggregation of each individual quality score for the document.

3. The method of claim 2, further comprising the steps of:
(a) determining a static rank calculation for the identified document; and
(b) applying the static rank calculation determined, as a seed value for the document quality score.

4. The method of claim 3, wherein the step of assigning an individual quality score further comprises the steps of:
(a) generating a positive score for an approved predetermined criterion; and
(b) generating a negative score for a disapproved predetermined criterion.

5. The method of claim 1, wherein the at least one predetermined criterion includes at least one of:
(a) a specified universal resource locator indicating a location of the document;
(b) an Internet domain within which the document is accessible;
(c) a list of content for the document, wherein the list of content is selected by an editorial board;
(d) a readability score for the document;
(e) a flag indicating a parameter of the document; and
(f) a list of disapproved content for the document.

6. The method of claim 1, wherein the step of associating the targeted content indication with the document comprises the step of appending a metadata targeted content indication to the document.

7. The method of claim 1, wherein the targeted content indication describes a relevance of the document to a specific search topic that is one of the following:
(a) education;
(b) sports;
(c) business;
(d) vehicles;
(e) politics;
(f) news;
(g) shopping;
(h) health; and
(i) travel.

8. The method of claim 1, further comprising the steps of:
(a) applying an agent algorithm used for crawling a network to identify documents for addition to the search index; and
(b) generating a new record for the documents thus identified, within the search index, the new record including the targeted content indication for each document identified.

9. The method of claim 1, wherein in response to a search inquiry, an ordered set of a plurality of documents in the search index is produced, an ordering of the documents in the ordered set being based on a relative value of the targeted content indication associated with each of the plurality of documents and a relevance to the search inquiry.

10. A computer implemented method for enabling an educationally targeted search query of a search index having a plurality of document entries, comprising the steps of:
(a) receiving a search request for a document search from a user device;
(b) determining if the search query includes a targeted content request for restricting search results to educationally targeted documents; and
(c) if so, submitting the search query to the search index, wherein each document entry of the search index includes a targeted content indicator that is based on a pre-evaluated targeted content analysis of the document, so that results of the search query will include only educationally targeted documents identified by the targeted content indicator for the documents in the search index.

11. The method of claim 10, further comprising the step of generating a search result list in response to the search query, the search result list being based on a search for search index targeted content indicators that match the targeted content request.

12. The method of claim 10, wherein the targeted content indicator comprises a targeted content score for each document that is determined based on predetermined criteria, the targeted content score for a document being one of a positive value, zero, and a negative value.

13. The method of claim 12, further comprising the step of searching the search index for documents having a highest value for the targeted content score.

14. The method of claim 12, further comprising the step of ordering the search result list based on the targeted content score for each of the documents included in the list.

15. The method of claim 14, further comprising the steps of:
(a) identifying each document in the search result list having a negative targeted content score;
(b) eliminating each document identified as having a negative targeted content score from the search result list producing a modified search result list; and
(c) sorting the modified search result list to produce a final search result list of documents having only positive targeted content scores.

16. The system of claim 15, further comprising the step of displaying the final search result list to a user.

17. A system for providing a search index that includes a targeted content indication for documents referenced by the search index, enabling a search of the search index for documents with the targeted content, comprising:
(a) a search index database that stores data comprising the search index with the targeted content indication;
(b) a server computer in communication with the search index database, the server computer including a processor, and a memory in communication with the processor, the memory storing machine instructions that when executed by the processor, cause the processor to carry out a plurality of functions, including:
(i) selecting documents in the search index database for analysis by a targeted content metric algorithm;
(ii) analyzing the documents with the targeted content metric algorithm to produce the targeted content indicator for each document, which is useable for ranking the documents in regard to their targeted content; and
(iii) associating the targeted content indicator with each document analyzed, producing the search index that includes the targeted content indication for the documents referenced by the search index.

18. The system of claim 17, wherein the targeted content metric algorithm performs a plurality of functions for each document analyzed, including:
(a) determining whether a document is associated with any of a plurality of a predetermined criteria;
(b) associating an individual quality score for each of the predetermined criteria with which the document is associated; and
(c) generating the targeted content indication for the document based on an aggregation of each individual quality score associated with the document.

19. The system of claim 18, wherein the targeted content metric algorithm performs a further plurality of functions for each document analyzed, including:
(a) determining a static rank calculation for the document;
(b) applying the determined static rank calculation as a seed value for the targeted content indication of the document; and
(c) adding each individual quality score to the applied seed value to produce the targeted content indication for the document.

20. The system of claim 17, wherein to associate the targeted content indication with the document, the processor appends a metadata document quality score to the document.
